(19) United States
(12) Patent Application Publication
(10) Pub. No.: US 2009/0046648 A1
(43) Pub. Date: Feb. 19, 2009

(54) Apparatus and method for generating MAC PDU in mobile communication system

(75) Inventors: Yang-Ick Joo, Seoul (KR); Do-Young Lee, Suwon-si (KR); Jun-Sung Lee, Uiwang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd., Suwon-si (KR)

(21) Appl. No.: 12/222,643

(22) Filed: Aug. 13, 2008

(30) Foreign Application Priority Data
Aug. 13, 2007 (KR) 2007-0081291

(51) Int. Cl. H04Q 7/00

(52) U.S. Cl. 370/329

(57) ABSTRACT

An apparatus and method for avoiding waste of resources by dynamically allocating a length of a Logical Channel IDentification (LCID) of a header included in a Media Access Control (MAC) Protocol Data Unit (PDU) are provided. The apparatus includes a header generator for evaluating a MAC Service Data Unit (SDU) to be multiplexed and for dynamically allocating LCID information according to the evaluated MAC SDU, when radio bearer information is modified. Accordingly, the conventional problem can be solved in which a large number of bits are unnecessarily wasted since the length of the LCID is fixedly allocated or in which logical channels cannot be sufficiently used.

### CROSS REFERENCE TO RELATED APPLICATION

This application claims the benefit under 35 U.S.C. § 119(a) of a Korean patent application filed in the Korean Intellectual Property Office on Aug. 13, 2007 and assigned Serial No. 2007-81291, the entire disclosure of which is hereby incorporated by reference.

### BACKGROUND OF THE INVENTION

1. Field of the Invention

The present invention relates to an apparatus and method for generating a Media Access Control (MAC) Protocol Data Unit (PDU) in a mobile communication system. More particularly, the present invention relates to an apparatus and method for avoiding waste of resources by dynamically allocating a length of a Logical Channel IDentification (LCID) of a header included in the MAC PDU.

2. Description of the Related Art

Mobile communication systems have recently developed to radio data packet communication systems that can provide data services and multimedia services with a high speed and high quality beyond the early voice-oriented services. A Universal Mobile Telecommunication Service (UMTS) system is a 3^{rd} Generation (3G) mobile communication system employing wideband Code Division Multiple Access (CDMA) and based on Global System for Mobile Communications (GSM) and General Packet Radio Services (GPRS) which are European mobile communication systems. The UMTS system provides a packet-based text, digitalized voice data or video and multimedia data with a speed over 2 Mbps to users who use mobile phones or mobile computers anywhere in the globe.

The UMTS system uses a concept of packet switching access using a packet protocol such as an Internal Protocol (IP), and can be connected to any nodes included in a network.

Standardization on the UMTS system is in progress in the 3^{rd} Generation Partnership Project (3GPP). A Long Term Evolution (LTE) is also being discussed in the 3GPP as a next generation mobile communication system for the UMTS system. The LTE is a technique for implementing high-speed packet-based communications with a speed of about 100 Mbps. A variety of schemes are being discussed for the LTE. Examples of the schemes currently being discussed for the LTE include a scheme for reducing the number of nodes located on a communication path by simplifying a network structure and a scheme for allowing radio protocols to fit radio channels as much as possible.

FIG. 1 illustrates an operation of a Media Access Control (MAC) entity in a conventional mobile communication system.

Referring to FIG. 1, Radio Link Control (RLC) layers 102 and 104 configure RLC Service Data Units (SDUs) received from a upper layer into one RLC Protocol Data Unit (PDU) and then transmit the RLC PDU to a MAC layer 106.

From the perspective of the MAC layer 106, the RLC PDU can be analyzed as a MAC SDU. The MAC layer 106 configures MAC headers and combines the MAC headers to configure one MAC PDU. In addition to the MAC SDUs delivered from the RLC layers 102 and 104, the MAC PDU can include MAC SDUs which are for providing controls and which are exchangeable between a transmitter and a receiver in MAC layers. Hereinafter, a MAC SDU for providing controls is referred to as ‘MAC-control-SDU’, and a MAC SDU for providing data transmission is referred to as ‘MAC-data-SDU’. The MAC-control-SDU may be included in one MAC PDU together with the MAC-data-SDU when transmitted. Alternatively, the MAC-control-SDU may be exclusively included in the MAC PDU when transmitted. Therefore, a MAC PDU header must be configured so that the MAC-data-SDU and the MAC-control-SDU can be distinguished from each other.

The MAC layer 106 generates a MAC PDU including a MAC PDU header configured as described above and transmits the MAC PDU to a PHYsical layer protocol (PHY) layer 108. The PHY layer 108 transmits the received MAC PDU to a PHY layer 110 of a receiving end. The PHY layer 110 transmits the received MAC PDU to a MAC layer 112 of the receiving end.

Upon receiving the MAC PDU, the MAC layer 112 reads the MAC PDU header included in the received MAC PDU and thus separates the MAC SDUs included in the MAC PDU header. Then, the MAC layer 112 provides the separated MAC SDUs to corresponding RLC layers 114 and 116.

FIG. 2 illustrates an example of a MAC PDU configuration in a mobile communication system according to an exemplary embodiment of the present invention. Referring to FIG. 2, the MAC PDU includes a MAC header 210 and an RLC PDU 220. The RLC PDU 220 includes one or more MAC SDUs (i.e., a MAC-control-SDU and a MAC-data-SDU) 222 and 224.

The MAC header 210 includes a MAC sub header 230. The MAC sub header 230 is constructed of a data/control (D/C) field 232, a length field (LF) 234, a Logical Channel IDentification (LCID) field 236, and an extension (E) field 238.

The D/C field 232 indicates whether each MAC SDU 222 or 224 is a MAC-control-SDU or a MAC-data-SDU. The D/C field 232 is set when the MAC SDU is the MAC-data-SDU.

The LF field 234 indicates a length of each MAC SDU 222 or 224 included in the MAC PDU. The LCID field 236 identifies respective MAC SDUs received from a plurality of logical channels. The LCID field 236 can be used to distinguish whether the MAC SDU of the RLC PDU 220 is the MAC-control-SDU or the MAC-data-SDU. Further, a fixed n-bit LCID is assigned to distinguish 2ⁿ logical channels.

The E field 238 indicates whether more multiplexed MAC SDUs are included in the MAC header. That is, if the E field 238 is set to 0, a current MAC SDU is a last MAC SDU, and if the E field 238 is set to 1, the current MAC SDU is followed by more multiplexed MAC SDUs.

As described above, the LCID field 236 is fixedly assigned with n bits to distinguish 2ⁿ logical channels. If the number of logical channels used in practice is less than 2ⁿ, the use of fixedly assigned n-bit LCID field may result in deterioration of transmission efficiency between a mobile terminal and a base station.

In a currently available LTE, the LCID field 236 is expected to be about 5 bits. However, the number of logical channels to be used in practice is expected to be less than 32 (=2⁵), which leads to deterioration in transmission efficiency. In addition, the logical channels cannot be used in some cases even if the number of logical channels to be used in practice for the support of various services is greater than 2ⁿ.

Accordingly, there is a need for an apparatus and method for avoiding deterioration in transmission efficiency by optimizing a MAC header of a MAC PDU, that is, by dynamically allocating a length of a fixed LCID field.

### SUMMARY OF THE INVENTION

An aspect of the present invention is to solve at least the above-mentioned problems and/or disadvantages and to provide at least the advantages described below. Accordingly, an aspect of the present invention is to provide an apparatus and method for generating a Media Access Control (MAC) Protocol Data Unit (PDU) having an optimized MAC header in a mobile communication system.

Another aspect of the present invention is to provide an apparatus and method for generating an optimized MAC PDU by dynamically allocating a length of a Logical Channel IDentification (LCID) when a MAC header is generated in a mobile communication system.

In accordance with an aspect of the present invention, a transmitting apparatus for generating a MAC header of a MAC PDU in a mobile communication system is provided. The apparatus includes a header generator for evaluating a MAC Service Data Unit (SDU) to be multiplexed and for dynamically allocating LCID information according to the evaluated MAC SDU, when radio bearer information is modified.

In accordance with another aspect of the present invention, a receiving apparatus for generating a MAC header of a MAC PDU in a mobile communication system is provided. The apparatus includes a header analyzer for evaluating an LCID by analyzing the MAC header of the MAC PDU and for providing each of SDU processors with a MAC SDU extracted according to the LCID.

In accordance with another aspect of the present invention, a mobile communication system for processing a MAC PDU is provided. The system includes a transmitting apparatus for generating a MAC header including an LCID dynamically allocated according to a MAC SDU, and a receiving apparatus for processing the MAC SDU by analyzing the dynamically allocated LCID.

In accordance with another aspect of the present invention, a method of generating a MAC header of a MAC PDU by a transmitting apparatus in a mobile communication system is provided. The method includes obtaining information required to generate the MAC header when radio bearer information is modified, evaluating a MAC SDU to be multiplexed using the obtained information, dynamically allocating LCID information according to the evaluated MAC SDU, and generating the MAC header having the allocated LCID information.

In accordance with another aspect of the present invention, a method of analyzing a MAC header of a MAC PDU by a receiving apparatus in a mobile communication system is provided. The method includes evaluating an LCID by analyzing the MAC header of the MAC PDU, and providing each of SDU processors with a MAC SDU extracted according to the LCID.

In accordance with another aspect of the present invention, a method of analyzing a MAC header of a MAC PDU in a mobile communication system is provided. The method includes generating, by a transmitting apparatus, a MAC header including an LCID dynamically allocated according to a MAC SDU, and processing, by a receiving apparatus, the MAC SDU by analyzing the dynamically allocated LCID.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 illustrates an operation of a Media Access Control (MAC) entity in a conventional mobile communication system;

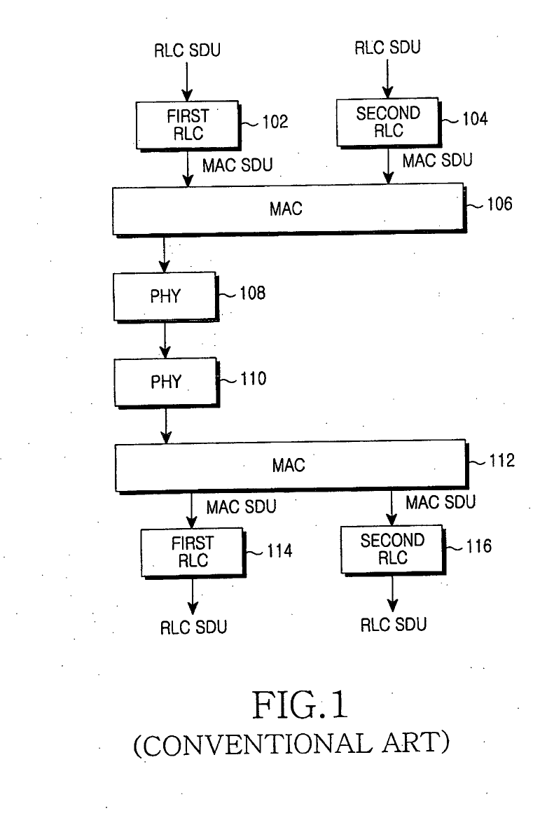

FIG. 2 illustrates an example of a MAC Protocol Data Unit (PDU) configuration in a mobile communication system according to an exemplary embodiment of the present invention;

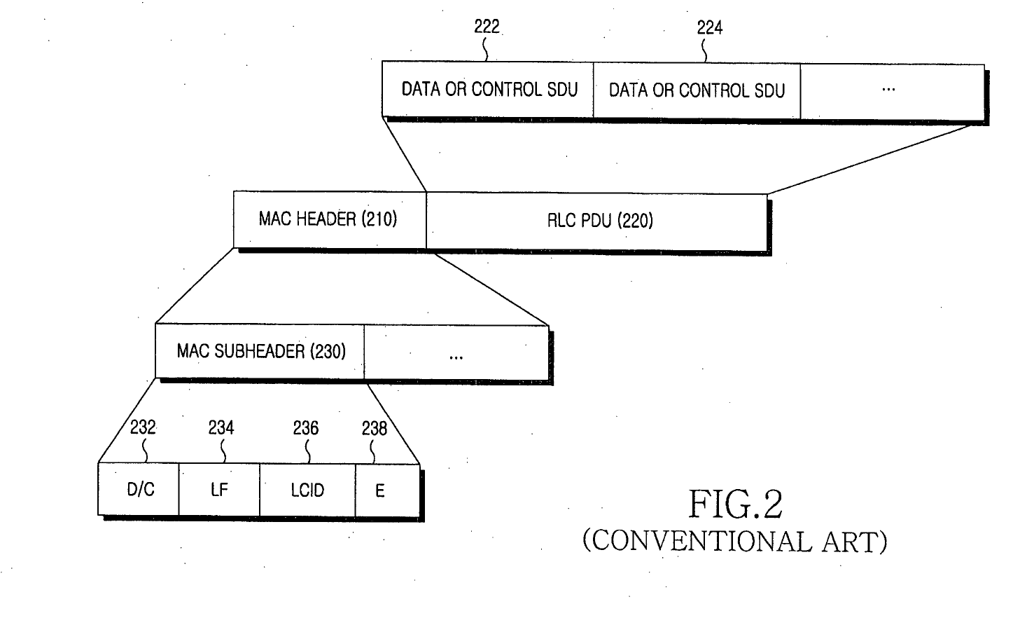

FIG. 3 is a block diagram illustrating a structure of a transmitting apparatus for generating a MAC header in which a length of a Logical Channel IDentification (LCID) is dynamically allocated according to an exemplary embodiment of the present invention;

FIG. 4 is a block diagram illustrating a structure of a receiving apparatus for receiving a MAC PDU in a mobile communication system according to an exemplary embodiment of the present invention;

FIG. 5 is a flowchart illustrating a process of generating a MAC header in which a length of an LCID is dynamically allocated by a transmitting apparatus in a mobile communication system according to an exemplary embodiment of the present invention; and

FIG. 6 is a flowchart illustrating a process of detecting a MAC PDU received by a receiving apparatus in a mobile communication system according to an exemplary embodiment of the present invention.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. Descriptions of well-known functions and constructions will be omitted for clarity and conciseness.

Hereinafter, an apparatus and method for generating a Media Access Control (MAC) Protocol Data Unit (PDU) by dynamically allocating a length of Logical Channel IDentification (LCID) of a header included in the MAC PDU will be described. The LCID could be included in the MAC sub header which composite the header.

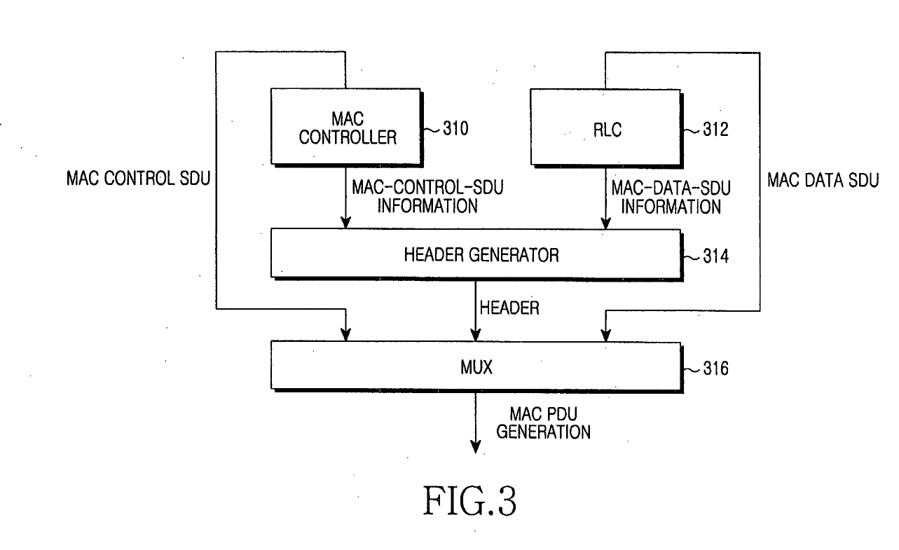

FIG. 3 is a block diagram illustrating a structure of a transmitting apparatus for generating a MAC header in which a length of an LCID is dynamically allocated according to an exemplary embodiment of the present invention.

Referring to FIG. 3, the transmitting apparatus includes a MAC controller 310, a Radio Link Control (RLC) 312, a header generator 314, and a MUltipleXer (MUX) 316.

The RLC 312 transmits to the MUX 316 a MAC SDU to be transmitted, and provides the header generator 314 with information (i.e., LCID information, length information, etc.) on the MAC SDU to be transmitted. Hereinafter, a MAC SDU for providing controls is referred to as ‘MAC-control-SDU’, and a MAC SDU for providing data transmission is referred to as ‘MAC-data-SDU’. If the MAC-control-SDU exists, the MAC controller 310 transmits the MAC SDU to the MUX 316, and provides the header generator 314 with LCID information and length information on the MAC-control-SDU.

The header generator 314 generates a MAC header by using LCID information and length information on MAC SDUs (i.e., a MAC-data-SDU and a MAC-control-SDU) received from the RLC 312 and the MAC controller 310.

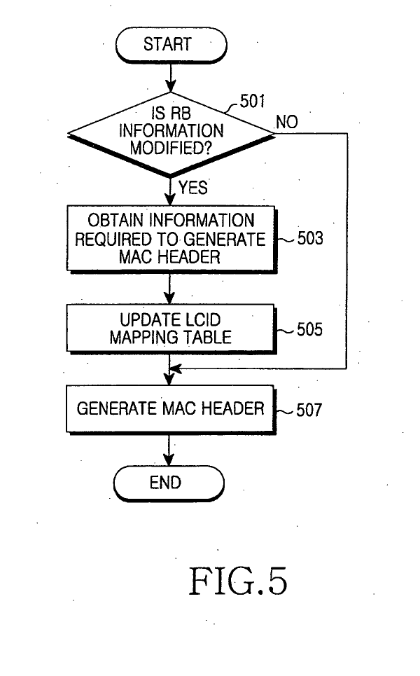

In this case, the header generator 314 may generate an optimized MAC header by dynamically allocating a length of the LCID of the MAC header. A process of dynamically allocating the length of the LCID to generate the optimized MAC header will be described below in detail with reference to FIG. 5.

The MUX 316 multiplexes the MAC SDUs and the MAC header received according to an order under the control of the header generator 314. Then, the MUX 316 generates and outputs a MAC PDU.

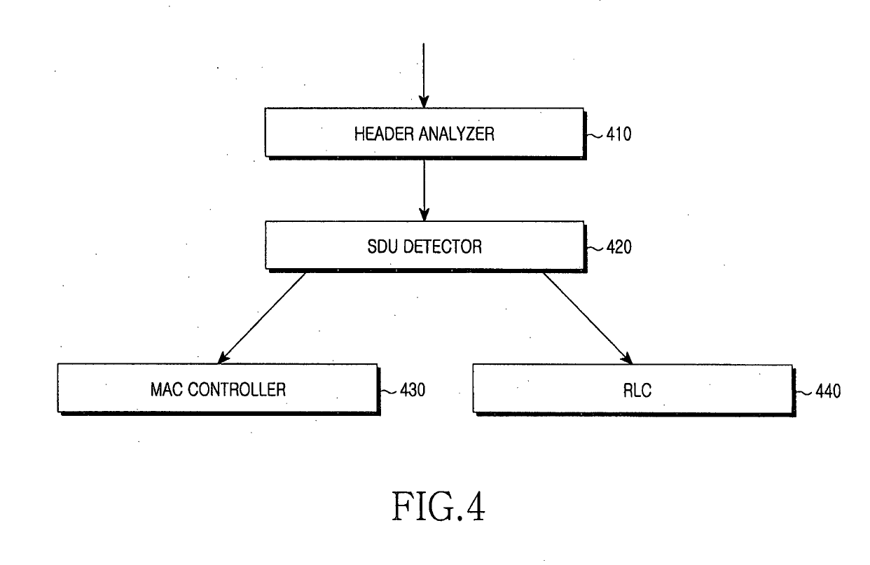

FIG. 4 is a block diagram illustrating a structure of a receiving apparatus for receiving a MAC PDU in a mobile communication system according to an exemplary embodiment of the present invention.

Referring to FIG. 4, the receiving apparatus includes a header analyzer 410, an SDU detector 420, a MAC controller 430, and an RLC 440.

Upon receiving a MAC PDU, the header analyzer 410 evaluates an LCID of the MAC PDU. Then, the header analyzer 410 provides the SDU detector 420 with LCID information and length information on respective MAC SDUs (i.e., a MAC-data-SDU and a MAC-control-SDU) multiplexed and included in the MAC PDU. The LCID information is defined in an LCID field, and the length information is defined in a length field.

By using the LCID information and the length information on the MAC SDUs received from the header analyzer 410, the SDU detector 420 extracts the MAC SDUs from the received MAC PDUs. Further, the SDU detector 420 processes the MAC SDUs extracted according to the LCID.

That is, the SDU detector 420 provides the RLC 440 with the MAC-data-SDU included in the RLC PDU of the MAC PDU, and provides the MAC controller 430 with the MAC-control-SDU included in the RLC PDU of the MAC PDU.

FIG. 5 is a flowchart illustrating a process of generating a MAC header in which a length of an LCID is dynamically allocated by a transmitting apparatus in a mobile communication system according to an exemplary embodiment of the present invention.

Referring to FIG. 5, it is determined whether Radio Bearer (RB) information is modified in step 501. The modification of RB information denotes a process of setup, reconfiguration, and release of the RB.

If the modification of RB information is not detected, MAC header 210 is generated in step 507 using the current LCID mapping table without updating.

Otherwise, if the modification of RB information is detected, information required to generate a MAC header is obtained in step 503. The process of obtaining the information required to generate the MAC header 210 may be performed by receiving information from the MAC controller 310 for generating a MAC-control-SDU and from the RLC 312 for generating a MAC-data-SDU. The information received from the MAC controller 310 and the RLC 312 is in regard to respective MAC SDUs to be transmitted by the MAC controller 310 and the RLC 312.

In step 505, an LCID mapping table is updated by the header generator 314. The LCID mapping table is a table in which LCID information is dynamically allocated depending on the modification of the RB information.

The process of updating the LCID table by the header generator 314 will be described with reference to Table 1 below.

It is assumed that the LCID table of the transmitting apparatus is configured as shown in Table 1 below.

TABLE 1

| LCID | RBID |
|---|---|
| 0 | 3 |
| 1 | 4 |
| 2 | 5 |

If an RB #2 is generated in a state when the mapping table is configured as shown in Table 1 above, the header generator 314 updates the LCID table as shown in Table 2 below.

TABLE 2

| LCID | RBID |
|---|---|
| 0 | 3 |
| 1 | 4 |
| 2 | 5 |
| 3 | 2 |

That is, when the RB #2 is generated, the header generator 314 sequentially allocates information on the generated RB #2 to the mapping table as shown in Table 2 above. The LCID fixed to n bits can be set to 2 bits, and thus the number of transmission bits of the LCID field 236 can be reduced. Decrease in the number of transmission bits can influence performance in terms of transmission efficiency when data is transmitted with a high speed such as in the 3GPP LTE system.

In addition, when RBs are released, the header generator 314 may update the LCID table of Table 2 above to a new LCID table as shown in Table 3 below.

TABLE 3

| LCID | RBID |
|---|---|
| 0 | 5 |
| 1 | 2 |

Table 3 shows a case where RBs #3 and #4 are released. The header generator 314 excludes the released RBs from the mapping table and sequentially allocates the remaining RBs. In the case of Table 3, the LCID fixed to n bits can be set to 1 bit.

In the aforementioned method of updating the mapping table, RBs are sequentially allocated according to an order of the LCID. However, the mapping table can also be sorted according to an order of a Radio Bearer IDentification (RBID).

In step 507, the MAC header 210 is generated by the header generator 314. Thereafter, the procedure of FIG. 5 ends.

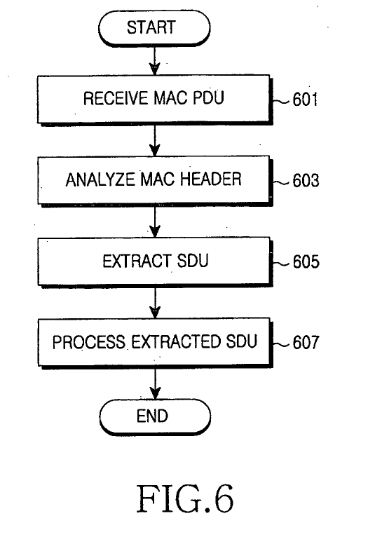

FIG. 6 is a flowchart illustrating a process of detecting a MAC PDU received by a receiving apparatus in a mobile communication system according to an exemplary embodiment of the present invention.

Referring to FIG. 6, a MAC PDU generated according to the procedure of FIG. 5 is received in step 601. The MAC header 210 of the received MAC PDU is analyzed and a LCID of the MAC header 210 is evaluated by the header analyzer 410 in step 603.

Thereafter, MAC SDUs are extracted from the MAC PDU in step 605. The MAC SDUs extracted according to LCIDs of the respective MAC SDUs are processed by the SDU detector 420 in step 607.

The SDU detector 420 provides the RLC 440 with a MAC-data-SDU included in the RLC PDU of the MAC PDU, and provides the MAC controller 430 with a MAC-control-SDU included in the RLC PDU of the MAC PDU.

Thereafter, the procedure of FIG. 6 ends.

According to the present invention, when a MAC header is generated, an optimized MAC PDU header is generated by dynamically allocating a length of an LCID. Therefore, a problem occurring in a MAC header generation method of the existing mobile communication system can be avoided. In other words, the conventional problem can be solved in which a large number of bits are unnecessarily wasted since the length of the LCID is fixedly allocated or in which logical channels cannot be sufficiently used.

In addition, when the MAC header is generated according to the present invention, the MAC PDU header is optimized at each time point by dynamically allocating the length of the LCID. Therefore, transmission efficiency between a mobile terminal and a base station can be improved.

While the present invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the scope of the invention is defined not by the detailed description of the invention but by the appended claims and their equivalents, and all differences within the scope will be construed as being included in the present invention.

What is claimed is:

1. A transmitting apparatus for generating a Media Access Control (MAC) header of a MAC Protocol Data Unit (PDU) in a mobile communication system, the apparatus comprising:
a header generator for evaluating a MAC Service Data Unit (SDU) to be multiplexed and for dynamically allocating Logical Channel IDentification (LCID) information according to the evaluated MAC SDU, when radio bearer information is modified.

2. The apparatus of claim 1, wherein the header generator allocates the LCID information when the radio bearer information is modified, that is, when the radio bearer information is set up, reconfigured, or released.

3. The apparatus of claim 2, wherein the header generator allocates the LCID information by using a minimum number of bits with which the evaluated MAC SDU can be represented.

4. A receiving apparatus for generating a MAC header of a MAC PDU in a mobile communication system, the apparatus comprising:
a header analyzer for evaluating an LCID by analyzing the MAC header of the MAC PDU and for providing each of SDU processors with a MAC SDU extracted according to the LCID.

5. A mobile communication system for processing a MAC PDU, the system comprising:
a transmitting apparatus for generating a MAC header comprising an LCID dynamically allocated according to a MAC SDU; and
a receiving apparatus for processing the MAC SDU by analyzing the dynamically allocated LCID.

6. A method of generating a MAC header of a MAC PDU by a transmitting apparatus in a mobile communication system, the method comprising:
obtaining information required to generate the MAC header when radio bearer information is modified;
evaluating a MAC SDU to be multiplexed using the obtained information;
dynamically allocating LCID information according to the evaluated MAC SDU; and
generating the MAC header having the allocated LCID information.

7. The method of claim 6, wherein the modification of the radio bearer information comprises at least one of setup, reconfiguration, and release of the radio bearer information.

8. The method of claim 6, wherein, in the dynamically allocating of the LCID information, the LCID is allocated by using a minimum number of bits with which the evaluated MAC SDU can be represented.

9. A method of analyzing a MAC header of a MAC PDU by a receiving apparatus in a mobile communication system, the method comprising
evaluating an LCID by analyzing the MAC header of the MAC PDU; and
providing each of SDU processors with a MAC SDU extracted according to the LCID.

10. A method of analyzing a MAC header of a MAC PDU in a mobile communication system, the method comprising
generating, by a transmitting apparatus, a MAC header comprising a LCID dynamically allocated according to a MAC SDU; and
processing, by a receiving apparatus, the MAC SDU by analyzing the dynamically allocated LCID.
